(19) United States
(12) Patent Application Publication
(10) Pub. No.: US 2015/0291354 A1
(43) Pub. Date: Oct. 15, 2015

(54) BAG STAND

(71) Applicant: Pratt Industries, Inc., Conyers, GA (US)

(72) Inventor: John Richard Muse, Douglasville, GA (US)

(21) Appl. No.: 14/748,772

(22) Filed: Jun. 24, 2015

Related U.S. Application Data
(63) Continuation of application No. 14/447,058, filed on Jul. 30, 2014, now Pat. No. 9,102,432.
Application No. 14/447,058 is a division of application No. 13/164,464, filed on Jun. 20, 2011, now Pat. No. 8,840,072.
(60) Provisional application No. 61/357,526, filed on Jun. 22, 2010.

(51) Int. Cl. B65F 1/14

(52) U.S. Cl. CPC B65F 1/1415; B65F 2220/101; B65F 2220/102; B65F 2240/138

(57) ABSTRACT

A method of assembling a bag stand includes the steps of: receiving a blank formable into a bag stand having at least one side panel, each side panel having a top end, a bottom end, a left end, and a right end, at least one side panel connected to at least one adjacent side panel by a bend line, the blank also having a plurality of panel tabs, each panel tab connected to the top end of at least one side panel by at least one bend line, each panel tab having at least one interfacing end for connection to at least one other of the plurality of panel tabs; and bending the blank along at least one bend line.

### CROSS-REFERENCE TO RELATED APPLICATIONS

This application is a continuation of U.S. application Ser. No. 14/447,058, filed Jul. 30, 2014, which is a divisional of U.S. application Ser. No. 13/164,464, filed Jun. 20, 2011, which issued into U.S. Pat. No. 8,840,072, on Sep. 23, 2014, which claims the benefit of U.S. Provisional Application No. 61/357,526 filed on Jun. 22, 2010, all of which are hereby specifically incorporated by reference herein in their entireties.

### FIELD

The present disclosure relates to refuse disposal. More specifically, this disclosure relates to apparatus for facilitating holding open and filling a refuse bag.

### BACKGROUND

To be discarded, refuse is typically bagged. However, refuse bags tend to be non-rigid and quite flexible. Particularly with lawn refuse, filling a refuse bag may become difficult when the refuse itself is non-solid or requires two hands to place into the bag. For example, leaves, needles, dirt, and sticks tend not to hold together when a user attempts to place such items in a bag. When attempting to place such items in the refuse bag, the refuse bag is subject to collapsing.

### SUMMARY

A bag stand is disclosed for supporting and holding open a refuse bag to facilitate filling the refuse bag. The bag support is oriented to allow the bag support and refuse bag together to stand vertically with respect to the ground and to allow a user to fill the refuse bag without the need to manually hold open the refuse bag.

### DESCRIPTION OF THE FIGURES

The features and components of the following figures are illustrated to emphasize the general principles of the present disclosure and are not necessarily drawn to scale. Corresponding features and components throughout the figures may be designated by matching reference characters for the sake of consistency and clarity.

FIG. 1 is a perspective view of a bag stand for use with a refuse bag wherein male panel tabs and female panel tabs are shown extending above the top end of the bag stand.

FIG. 2 is a schematic view of the inside of a blank formable into the bag stand of FIG. 1.

FIG. 3 is a perspective view of the bag stand of FIG. 1 showing the folding action of the male panel tabs.

FIG. 4 is a perspective view of the bag stand of FIG. 1, wherein the male panel tabs have been folded, showing the folding action of the female panel tabs.

FIG. 5 is a perspective view of the bag stand of FIG. 1 in a final stand shape.

FIG. 6 is a side view of the bag stand of FIG. 1 in a flattened arrangement.

FIG. 7 is a perspective view of the bag stand of FIG. 6 while being unflattened.

FIG. 8 is a perspective view of the bag stand of FIG. 5 with a refuse bag inserted inside.

FIG. 9 is a perspective view of the bag stand of FIG. 5 with a refuse bag placed over the outside.

FIG. 10 is a perspective view of the bag stand of FIG. 9 in use.

### DETAILED DESCRIPTION

Disclosed is a bag stand to assist holding and filling refuse bags. It should be emphasized that the embodiments described herein are merely possible examples of implementations, merely set forth for a clear understanding of the principles of the present disclosure. Many variations and modifications may be made to the described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

One should note that conditional language, such as, among others, “can,” “could,” “might,” or “may,” unless specifically stated otherwise, or otherwise understood within the context as used, is generally intended to convey that certain embodiments include, while alternative embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment. Unless stated otherwise, it should not be assumed that multiple features, embodiments, solutions, or elements address the same or related problems or needs.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

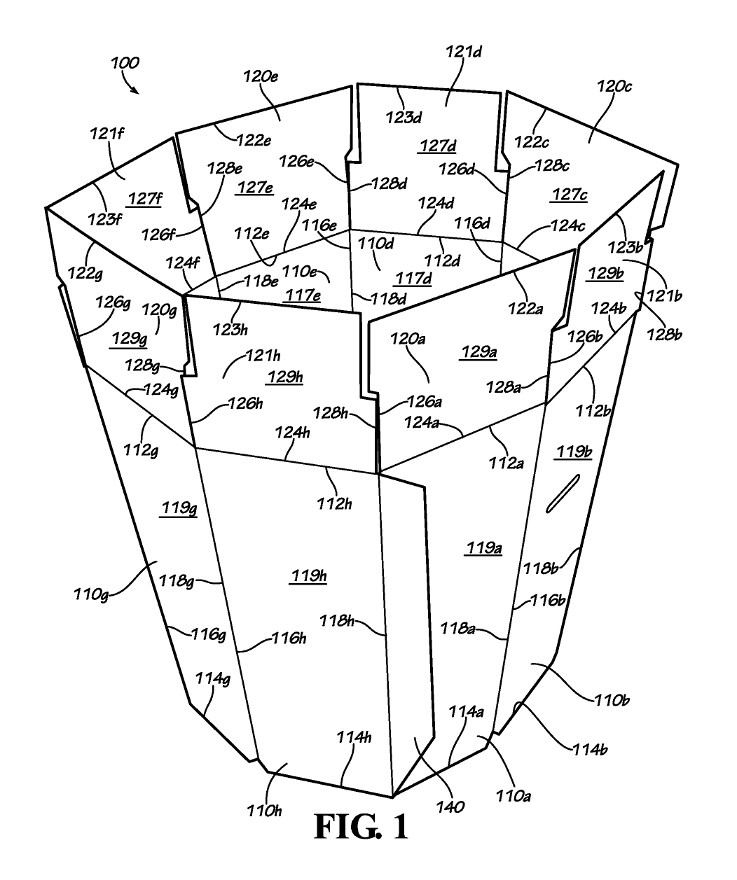

FIG. 1 displays a bag stand 100 having a plurality of side panels 110(a,b,c,d,e,f,g,h) connected to each other and arranged along the outside of the bag stand 100 to form a hollow structure for holding a refuse bag.

The current embodiment of the bag stand 100 includes eight side panels 110a,b,c,d,e,f,g,h. Any number of side panels 110 may be used in alternative embodiments so long as the side panels 110 are formable into the bag stand 100 from a flattened position, as will be discussed further. In the current embodiment, all side panels 110a,b,c,d,e,f,g,h are dimensioned about the same size and are about rectangular in shape. However, in alternative embodiments, the side panels 110 may be of different sizes or shapes from each other and from the current embodiment.

Each of the side panels 110 has a top end 112, a bottom end 114, a left end 116, and a right end 118. The side panels 110 are connected to each other having the left end 116 of one side panel 110 connected to the right end 118 of an adjacent side panel 110.

All references to “left” and “right” in this disclosure are intended to refer to the left and right directions when viewed from the outside with the top end up and the bottom end down. All connections to which this disclosure refers may be any connection sufficient to hold together the elements to be connected, including an integrated construction, glue, a notched end, or other types of connecting means.

Connected to the top end 112 of each side panel 110 is one of a female panel tab 120 or a male panel tab 121. Although panel tabs 120,121 are connected to each side panel 110 in the current embodiment, the panel tabs 120,121 need not be included on every side panel 110. Moreover, the panel tabs need not be female panel tabs 120 or male panel tabs 121 in all embodiments, and the specific arrangement of female panel tabs 120 and male panel tabs 121 may change from one embodiment to another.

Each of the panel tabs 120,121 has a bottom end 124, a left end 126, and a right end 128. The bottom ends 124 of the panel tabs 120,121 are connected to the top ends 112 of the side panels 110. Although the panel tabs 120,121 are connected to the side panels 110, they are not connected to other panel tabs 120,121. This connection allows each panel tab 120,121 to hinge with respect to the side panel 110 to which it is connected. Female panel tabs 120 have top ends 122. Male panel tabs 121 have top ends 123.

Attached to the right end 118h of side panel 110h is a connection panel 140. The connection panel 140 overlaps the side panel 110a and provides an interface for the side panels 110a and 110h to form a connected hollow structure. In the current embodiment, the connection panel 140 is glued to side panel 110a. All other connections are integrated in the current embodiment. Side panels 110a and 110h are connected so that the left end 116a of side panel 110a is collinear with the right end 118h of side panel 110h. Although the two side panels 110a and 110h are connected through connection panel 140, they are still “connected” as described in this disclosure. The left end 116a and right end 118h need not be collinear in order to be considered connected within this disclosure.

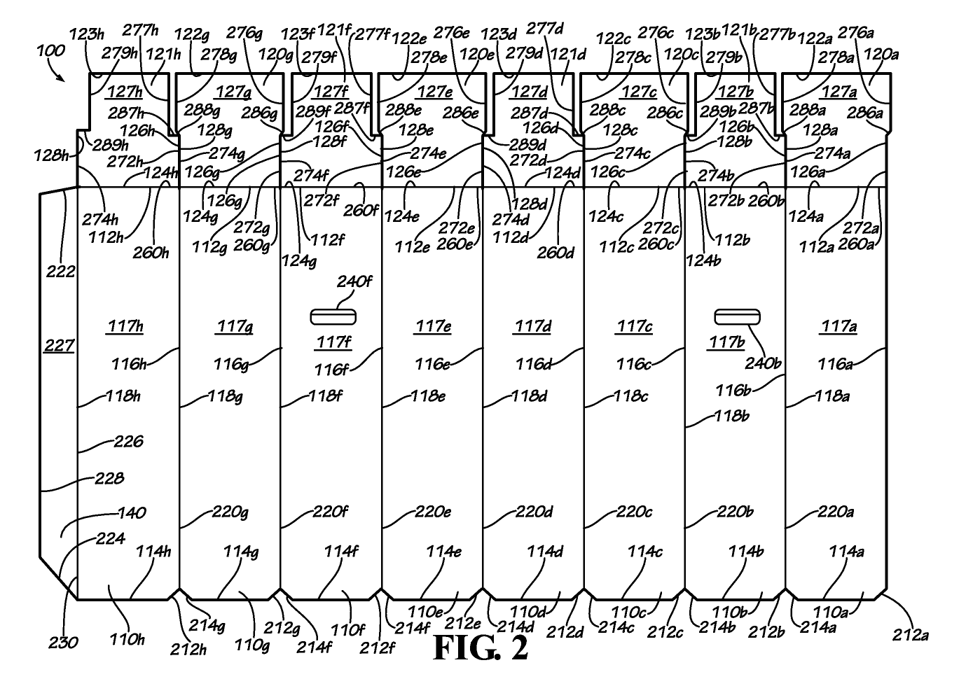

FIG. 2 displays an inside view of the bag stand 100 in a blank arrangement. The bag stand 100 is formable from a single cardboard blank. Each side panel 110a,b,c,d,e,f,g has two draft cutouts at its bottom end 114a,b,c,d,e,f,g—a left side draft 212a,b,c,d,e,f,g and a right side draft 214a,b,c,d,e,f,g. Side panel 110h has only a left side draft, 212h. The left side drafts 212 and right side drafts 214 in the current embodiment are about forty-five degree) (45° with respect to the bottom ends 124, the left ends 126, and the right ends 128 of the side panels 110, although other angular configurations are considered within this embodiment. Moreover, other shapes besides linear drafts are considered to be included as well. When assembled, the drafts 212,214 provide an escape for air passing from the inside to the outside of the bag stand 100.

At the intersection of each side panel 110 with an adjacent side panel 110 is a bend line. Bend lines to which this disclosure refers are designated as weakened regions and may include a crease, a perforation, a series of perforations, or another arrangement to weaken the area of the bend line to promote bending along the bend line. In the current embodiment, bend lines are creased to provide a hinged connection. Between right end 118a and left end 116b is bend line 220a; between right end 118b and left end 116c is bend line 220b; between right end 118c and left end 116d is bend line 220c; between right end 118d and left end 116e is bend line 220d; between right end 118e and left end 116f is bend line 220e; between right end 118f and left end 116g is bend line 220f; between right end 118g and left end 116h is bend line 220g.

The connection panel 140 has a top end 222, a bottom end 224, a left end 226, and a right end 228. The top end 222 of the connection panel 140 is formed at a downward angle with respect to the top ends 112a,b,c,d,e,f,g,h of the side panels 110a,b,c,d,e,f,g,h. Similarly, the bottom end 224 is formed with an upward angle with respect to the bottom ends 114,a,b,c,d,e,f,g,h of the side panels 110a,b,c,d,e,f,g,h. The angles of the top end 222 and the bottom end 224 create a shorter right side 228 than left side 226 of the connection panel 140. At the connection of the left end 226 of the connection panel 140 to the right end 118h of the side panel 110h is a bend line 230.

At the intersection of each side panel 110 with each panel tab 120,121 is a bend line 260. Each bend line 260a,b,c,d,e,f,g,h is located between each top end 112a,b,c,d,e,f,g,h of each side panel 110a,b,c,d,e,f,g,h and each bottom end 124a,b,c,d,e,f,g,h of each panel tab 120a,c,e,g; 121b,d,f,h. The panel tabs 120a,c,e,g and 121b,d,f,h are connected only by the bend lines 260a,b,c,d,e,f,g,h and otherwise are not connected in the current embodiment, although other configurations are possible and considered within this disclosure. The single connection line of each panel tab 120a,c,e,g and 121b,d,f,h allows each panel tab 120a,c,e,g and 121b,d,f,h to be bent along its bend line 260a,b,c,d,e,f,g,h.

Located on side panels 110b and 110f proximate the top ends 112b and 112f are handle cutouts 240b and 240f, respectively. The handle cutouts 240b,f are generally ovular cutouts of material from the side panels 110b,f sized to accommodate the hands of a user. The handle cutouts 240b,f may be supplied as holes on the side panels 110b,f. In another embodiment, the handle cutouts 240b,f may be punchout regions supplied with weakened perforations to allow a user to punch through and remove material thereby forming a hole or cutout.

In alternative embodiments, the handle cutouts 240b and 240f may be in different places on the bag stand. For example, in some embodiments, the handle cutouts 240b and 240f may be placed closer to the top ends 112b and 112f; in some embodiments, the location of the handle cutouts 240b and 240f will necessitate corresponding cutouts in the panel tabs 121b and 121f. Moreover, in alternative embodiments, the handle cutouts 240b and 240f may be placed on other side panels 110a,b,c,d,e,f,g,h.

For each panel tab 120a,c,e,g and 121b,d,f,h, the width distance between each of the left end 126a,b,c,d,e,f,g,h and right end 128a,b,c,d,e,f,g,h of the panel tabs 120a,c,e,g and 121b,d,f,h is the same width as the side panel 110a,b,c,d,e,f,g,h to which each panel tab 120a,c,e,g and 121b,d,f,h is connected proximate the bottom end 124a,b,c,d,e,f,g,h of each panel tab 120a,c,e,g and 121b,d,f,h.

For the female panel tabs 120a,c,e,g, each left end 126a,c,e,g has a standard portion 272a,c,e,g, a flaring portion 276a,c,e,g, and a draft portion 286a,c,e,g. Likewise, each right end 128a,c,e,g of each female panel tab 120a,c,e,g has a standard portion 274a,c,e,g, a flaring portion 278a,c,e,g, and a draft portion 288a,c,e,g. The flaring portions 276,278 of the female panel tabs 120 are connected to the draft portions 286,288 which are further connected to the standard portions 272,274, respectively. The draft portions 286,288 are angled with respect to the other portions of the left end 126 and right end 128. The connections create a wider length top end 122 than bottom end 124 for each female panel tab 120a,c,e,g.

For the male panel tabs 121b,d,f,h, each left end 126b,d,f,h has a standard portion 272b,d,f,h, a compressed portion 277b,d,f,h, and a lateral portion 287b,d,f,h. Likewise, each right end 128b,d,f,h has a standard portion 274b,d,f,h, a compressed portion 279b,d,f,h, and a lateral portion 289b,d,f,h. Each standard portion 272,274 is connected to each compressed portion 277,279 by each lateral portion 287,289, respectively. The lateral portions 287,289 are parallel to the top ends 123 and bottom ends 124 of the male panel tabs 121. The connections create a narrower length top end 123 than bottom end 124 for each male panel tab 121b,d,f,h. Both the left ends 126 and the right ends 128 of each male panel tab 121 and female panel tab 120 are interfacing ends in the current embodiment, although they need not be in alternative embodiments. The interfacing ends in the current embodiment allow the panel tabs 120,121 to connect together, keeping the bag stand 100 in an open arrangement.

In alternative embodiments, features of the panel tabs 120,121 may be different or removed. For example, in one alternative embodiment, the left end 126a does not include draft portion 286a or flaring portion 276a. Likewise, in one alternative embodiment, right end 128h does not include lateral portion 289h or compressed portion 279h.

The bag stand 100 is formed by folding the side panels 110a,b,c,d,e,f,g,h and connection panel 140 by their bend lines 220a,b,c,d,e,f,g and 230 until the connection panel 140 contacts the side panel 110a. In the current embodiment, shown in FIG. 1, the connection panel 140 overlaps the side panel 110a so that an inner surface 227 of the connection panel 140 contacts an outer surface 119a of the side panel 110a. The connection panel 140 is affixed to the side panel 110a by gluing. Other configurations are contemplated within this disclosure, including the connection panel 140 overlapping an inner surface 117a of the side panel 110a, connections by connecting tabs or key fit arrangements between the panels, and integrated connection, among others. When the connection is established, the left end 116a of the side panel 110a is about aligned with the right end 118h of the side panel 110h, although it need not be aligned in every embodiment.

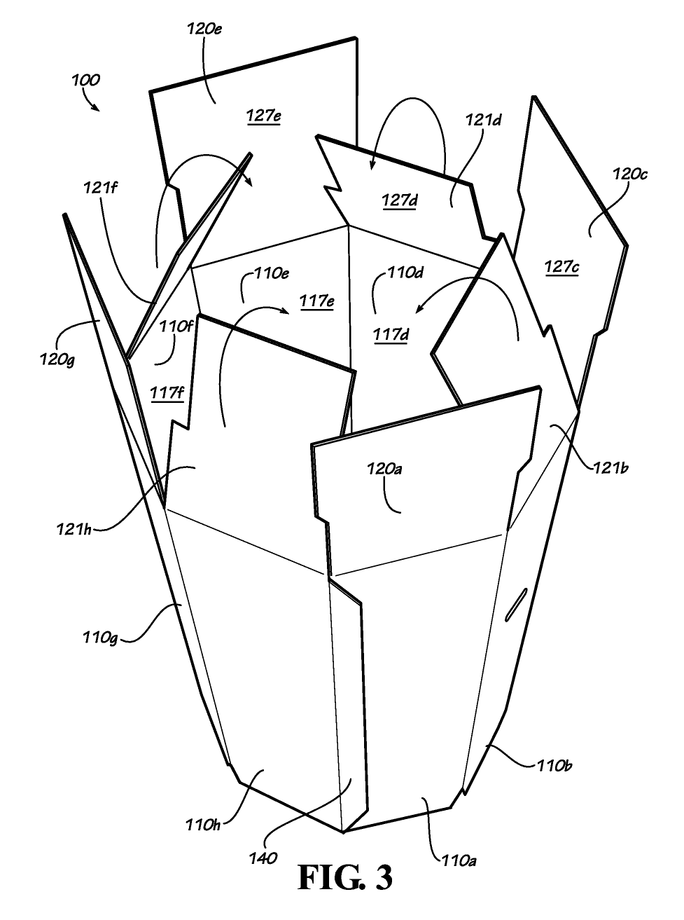

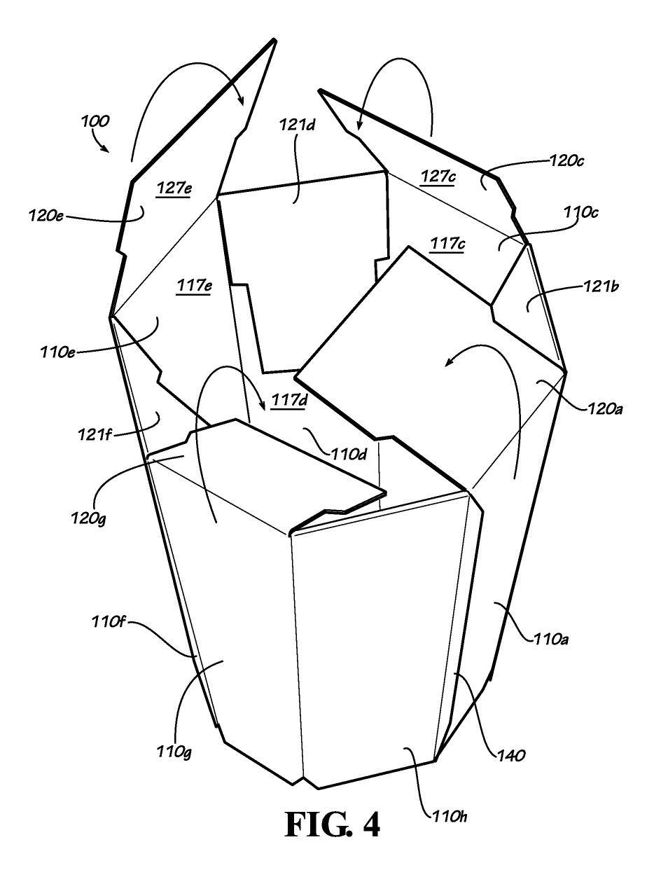

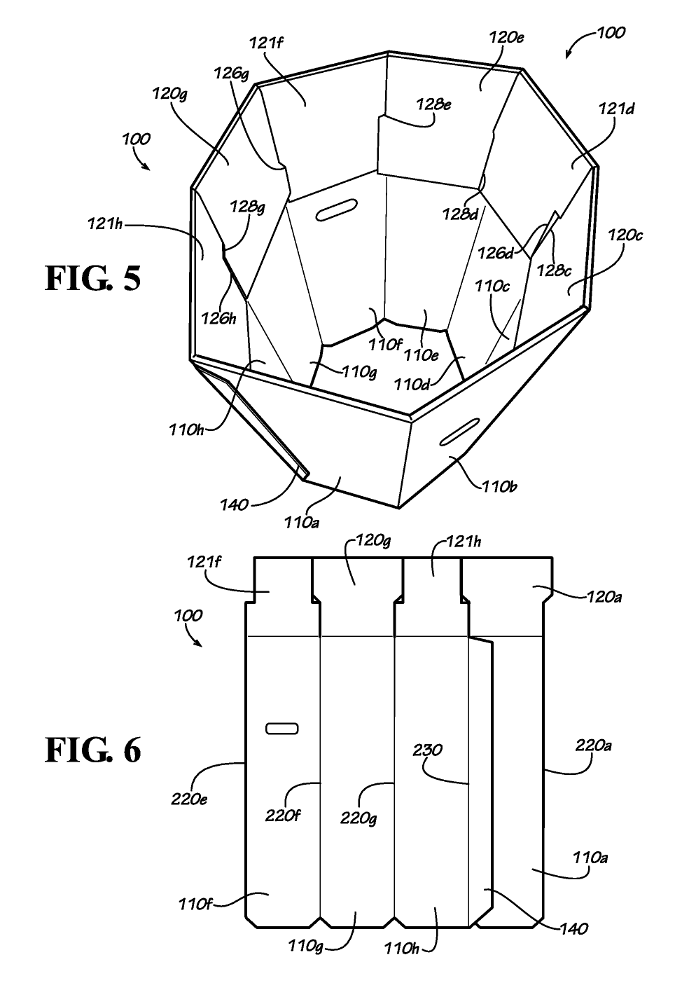

In the configuration of FIG. 1, the side panels 110 are all connected so that their top ends 112 together form a top end of the bag stand 100. The panel tabs 120,121 are shown raised from the top end of the bag stand 100. To form a completed bag stand, a user first folds the male panel tabs 121 in so that inner surfaces 127 of the male panel tabs 121 approach, and potentially contact, inner surfaces 117 of the side panels 110, as seen in FIG. 3. The user then folds the female panel tabs 120 so that the inner surfaces 127 of the female panel tabs 120 approach, and potentially contact, the inner surfaces 117 of the side panels 110, as seen in FIG. 4. For each male panel tab 121, the left ends 126 of the male panel tabs 121 interface with the right ends 128 of adjacent female panel tabs 120, and the right ends 128 of the male panel tabs 121 interface with the left ends 126 of adjacent female panel tabs 120. The flaring portions 276,278 of the female panel tabs 120 interface with the compressed portions 277,279 of the male panel tabs 121, forming a substantially interlocking interface, as seen in FIG. 5. Because the panel tabs 120,121 are substantially rigid, the substantially interlocking interface prevents collapse of the bag stand 100. Although a substantially interlocking interface is described, other arrangements sufficient to hold the bag stand 100 in an upright and uncollapsed position should be considered included within this disclosure.

As seen in FIG. 6, in some embodiments the bag stand 100 will be provided to the user in a flattened arrangement. The bag stand 100 is flattened by having bend lines 220a and 220e bent with all other bend lines unbent. The connection panel 140 is attached to the side panel 110a. In this arrangement, the bag stand 100 is easily shipped and is easily stored. Moreover, connection panel 140 is glued to side panel 110a such that a user of the bag stand 100 need only unbend somewhat along bend lines 220a and 220e while bending along bend lines 220b,c,d,f,g and 230 to form the bag stand 100 of FIG. 1. The unbending and bending process is shown in perspective view in FIG. 7. The user then need follow the steps described above and shown in FIGS. 3 and 4 to form the completed bag stand 100 of FIG. 5.

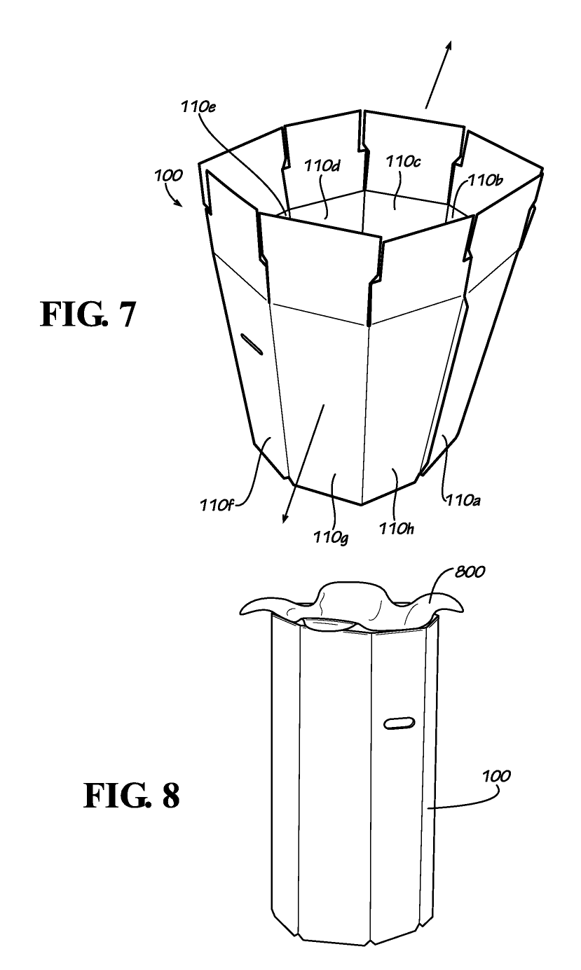

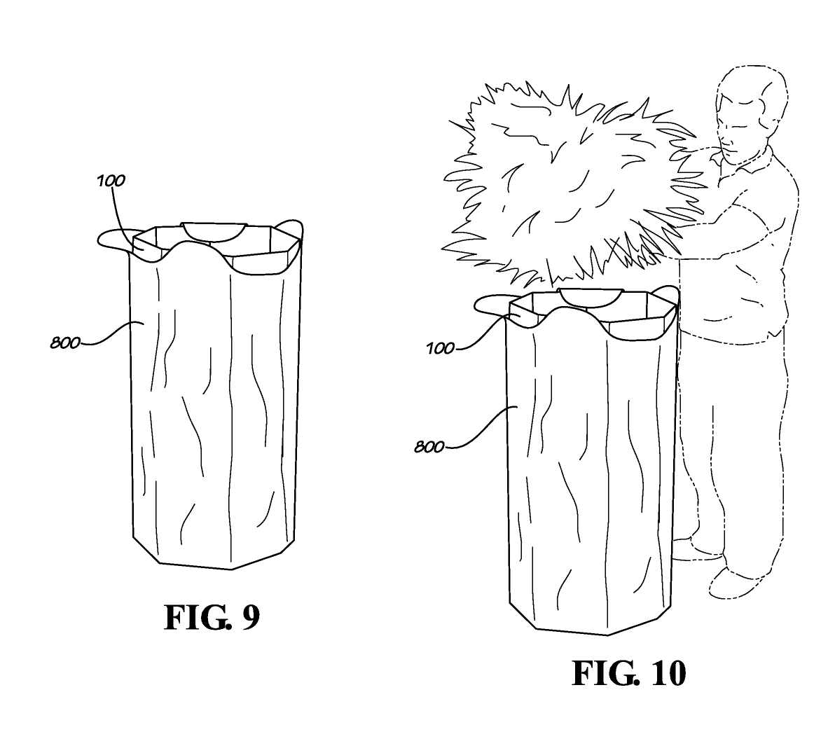

Once the bag stand 100 is configured in the arrangement of FIG. 5, a refuse bag 800 may be inserted into the bag stand 100, as seen in FIG. 8, or placed over the outside of the bag stand 100, as seen in FIG. 9. In the current embodiment, the refuse bag 800 is a plastic refuse bag, although other refuse bags may be implemented in alternative embodiments. The bag stand 100 is sized to accommodate a specific sized refuse bag 800, and other sizes of bag stands 100 may be used with other sizes of refuse bags 800.

Once the bag stand 100 and refuse bag 800 are configured together, a user may fill the refuse bag with refuse, as seen in FIG. 10. The refuse may include any type of refuse, including lawn refuse, trash, and biodegradable waste, among others. When the refuse bag 800 is appropriately filled with refuse, the user may discard the refuse bag 800, the refuse, and the bag stand 100 together. The user may optionally remove the bag stand 100 from the refuse bag 800, discarding the refuse bag 800 and refuse while retaining the bag stand 100 for later use. A user may also disassemble the bag stand 100, reversing the assembly steps shown in FIGS. 3-7 and described above with reference to those figures.

Where materials are chosen for the elements of this assembly—particularly, corrugated cardboard—similar generally rigid material choices may also be used and would be obvious to one in the art, including corrugated cardboard or paper, linerboard, polymer, plastic, metal, alloy, wood, mesh, laminate, reinforced woven or nonwoven fabric, cellulose, composite, and combinations or mixtures of the foregoing, among others.

That which is claimed is:

1. A method of assembling a bag stand comprising the steps of:
receiving a blank formable into a bag stand having at least one side panel, each side panel having a top end, a bottom end, a left end, and a right end, at least one side panel connected to at least one adjacent side panel by a bend line, the blank also having a plurality of panel tabs, each panel tab connected to the top end of at least one side panel by at least one bend line, each panel tab having at least one interfacing end for connection to at least one other of the plurality of panel tabs; and
bending the blank along at least one bend line.

2. The method of claim 1, wherein the blank also includes at least one connection panel connected to at least one side panel by at least one bend line.

3. The method of claim 1, wherein each panel tab is one of a male panel tab and a female panel tab.

4. The method of claim 1, wherein the blank includes at least one handle cutout.

5. The method of claim 1, wherein the blank includes an even number of side panels.

6. The method of claim 1, wherein the blank includes eight side panels.

7. The method of claim 1, wherein at least one side panel includes at least one left side draft.

8. The method of claim 1, wherein at least one side panel includes at least one right side draft.

9. A method of assembling a bag stand comprising the steps of:
receiving a bag stand having at least one side panel, each side panel having a top end, a left end, and a right end, the right end of each at least one side panel connected to the left end of at least one adjacent side panel, the bag stand also having a plurality of panel tabs, each panel tab connected to the top end of at least one side panel, the bag stand in a flattened arrangement; and
unflattening the bag stand to a shape sufficient to hold open a refuse bag, the shape defining a cross-sectional shape of the bag stand.

10. The method of claim 9, wherein a first panel tab of the plurality of panel tabs has a first interfacing end and a second panel tab of the plurality of panel tabs has a second interfacing end, the method further comprising arranging the first panel tab and the second panel tab such that the first interfacing end of the first panel tab interfaces with the second interfacing end of the second panel tab to form a top end of the bag stand.

11. The method of claim 9, wherein each panel tab is one of a male panel tab and a female panel tab.

12. The method of claim 9, wherein at least one side panel includes at least one left side draft.

13. The method of claim 9, wherein at least one side panel includes at least one right side draft.

14. The method of claim 9, further comprising the step of:
bending the plurality of panel tops relative to the top end of the bag stand, the right end and left end of each panel tab interfacing with the adjacent panel tabs, such that the inner surface of each panel tab is positioned adjacent to and facing the inner surface of a corresponding one of the left side panel, right side panel, and the at least one intermediate side panel, thereby forming a substantially interlocking interface between each panel tab, the plurality of panel tabs thereby defining an opening at the top end of the bag stand.

15. The method of claim 9, wherein each side panel is connected to one panel tab.

16. The method of claim 9, wherein each panel tab is connected to one side panel.

17. A method of using a bag stand comprising the steps of:
receiving a bag stand having at least one side panel, each side panel having a top end, a bottom end, a left end, and a right end, the right end of each at least one side panel connected to the left end of at least one adjacent side panel, the bag stand having a top end and a bottom end, the bag stand also having a plurality of panel tabs, each panel tab hingedly connected to the top end of at least one side panel, each panel tab having at least one interfacing end for connection to at least one other of the plurality of panel tabs;
receiving a refuse bag having a top end and a bag portion, the bag portion being substantially continuous and having an inner surface and an outer surface, the top end defining an opening; and
inserting refuse into the opening of the refuse bag.

18. The method of claim 17, further comprising the step of:
standing the bag stand by placing the bottom end of the bag stand downward.

19. The method of claim 17, further comprising the step of:
supporting the bag portion of the refuse bag by one of
inserting the bag portion of the refuse bag into the opening of the bag stand to occupy at least a portion of the cavity; and
inserting the bag stand through the opening of the refuse bag and into the bag portion of the refuse bag.

20. The method of claim 17, further comprising the step of:
orienting the bag stand in a sufficient shape to hold open a refuse bag, wherein the top end of the bag stand defines an opening and wherein the bag stand defines a cavity therein in communication with the opening.
